(19) United States
(12) Patent Application Publication
(10) Pub. No.: US 2026/0057024 A1
(43) Pub. Date: Feb. 26, 2026

(54) SYSTEMS AND METHODS FOR APPLYING MACHINE-LEARNING TO MULTIMODAL CONTEXT TO SEMANTICALLY INTERPRET A REAL-WORLD ENVIRONMENT

(71) Applicant: Capital One Services, LLC, McLean, VA (US)

(72) Inventors: Owen REINERT, Queens, NY (US); Samuel SHARPE, Cambridge, MA (US); Brian BARR, Schenectady, NY (US); Jeremy GOODSITT, Champaign, IL (US)

(73) Assignee: Capital One Services, LLC, McLean, VA (US)

(21) Appl. No.: 18/815,083

(22) Filed: Aug. 26, 2024

(51) Int. Cl. G06F 16/9537; G06F 16/9535

(52) U.S. Cl. CPC G06F 16/9537; G06F 16/9535

(57) ABSTRACT

A computer-implemented method for semantically interpreting a real-world environment may include: receiving, via a user device, multimodal input that includes a plurality of modalities of data regarding an environment associated with a user of the user device; standardizing the plurality of modalities into a uniform data format to generate uniform multimodal context data; generating an embedding of the uniform multimodal context data; and determining a content entry predicted to be relevant to the environment associated with the user based on the generated embedding.

### TECHNICAL FIELD

Various embodiments of this disclosure relate generally to applying machine-learning techniques to multi-modal input in order to semantically understand a real-world environment, and, more particularly, to systems and methods for converting multi-modal sensory input into a standardized embedding in order to determine a context for a real-world environment, and serving content that is semantically applicable to the context.

### BACKGROUND

A general goal for content delivery, be it advertising, entertainment, knowledge, assistance, etc., is to provide content that is applicable to the context in which it is presented. For internet technologies, this context generally arises from other content that is already being displayed on a user device. In an example, a visited webpage may provide context related to a user's interests, needs, or activities that may be leveraged to deliver additional relevant content. However, such an online context generally does little to inform about a user's real-world environment and the interests, needs, or activities that may be present in the real world, but that may or may not be represented in the user's online activity.

Some solutions may attempt to leverage an aspect of real-world data, such as location-aware application to provide directions or location-based recommendations. However, such solutions generally utilize a relatively narrow understanding of the world, and do not understand a deeper context for the real-world environment occupied by a user.

This disclosure is directed to addressing challenges such as one or more of those referenced above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for semantically understanding a real-world environment by applying machine-learning techniques to multi-modal input. Sensory input from multiple modalities is transitioned into a standardized embedding which may be used to determine a context for the real-world environment. The determined context may then be leveraged to identify content that is semantically relevant to that environment.

In one aspect, an exemplary embodiment of a computer-implemented method for semantically interpreting a real-world environment may include: receiving, via a user device, multimodal input that includes a plurality of modalities of data regarding an environment associated with a user of the user device; standardizing the plurality of modalities into a uniform data format to generate uniform multimodal context data; generating an embedding of the uniform multimodal context data; and determining a content entry predicted to be relevant to the environment associated with the user based on the generated embedding.

In another aspect, an exemplary embodiment of a method for computer-implemented method of semantically linking content to a real-world environment may include: causing each of a plurality of user devices to: capture multimodal input that includes a plurality of modalities of data regarding a respective environment associated with a user of each user device; and standardizing the plurality of modalities into a uniform data format to generate uniform multimodal context data; obtaining, from the plurality of user devices, context information based on the uniform multimodal context data; and matching one or more content entries to the plurality of user devices based on the context information.

In a further aspect, an exemplary embodiment of a system for semantically interpreting a real-world environment may include: a memory storing instructions; a plurality of data modality inputs; and a processor operatively connected to the memory and the plurality of data modality inputs, and configured to execute the instruction to perform operations. The operations may include: capturing, via the plurality of data modality inputs, multimodal input that includes a plurality of modalities of data regarding an environment associated with a user of the system; standardizing the plurality of modalities into a uniform data format to generate uniform multimodal context data; generating an embedding of the uniform multimodal context data; and determining a content entry predicted to be relevant to the environment associated with the user based on the generated embedding.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary infrastructure for semantically interpreting a real-world environment, according to one or more embodiments.

FIG. 2 depicts a flowchart of an exemplary method of semantically interpreting a real-world environment, according to one or more embodiments.

FIG. 3 depicts a flowchart of another exemplary method of semantically interpreting a real-world environment, according to one or more embodiments.

FIG. 4 depicts an example of a computing device, according to one or more embodiments.

### DETAILED DESCRIPTION OF EMBODIMENTS

According to certain aspects of the disclosure, methods and systems are disclosed for semantically understanding a real-world environment and delivering relevant content. It is generally desirable to deliver content that is relevant, applicable, or pertinent to the one receiving it. However, conventional techniques may not be suitable. For example, conventional techniques for content delivery may be adapted to online activity, but may not be suitable for determining context in a real-world environment. Accordingly, improvements in technology relating to semantic understanding of a real-world environments are needed.

As will be discussed in more detail below, in various embodiments, systems and methods are described for semantic understanding of a real-world environment. By utilizing machine-learning techniques, e.g., supervised or semi-supervised learning, associations may be learned between different modalities or combinations of modalities of sensory input and different contexts. Content associated with such contexts may thus be delivered to environments in which it is semantically relevant, pertinent, or applicable.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, or renting items to persons such as a seller, dealer, renter, merchant, vendor, or the like, as well as an agent or intermediary of such an entity or person. An “item” generally encompasses a good, service, or the like having ownership or other rights that may be transferred. A provider also encompasses a person or entity that provides or seeks to provide content to one or more persons. As used herein, “content” generally encompasses notifications, information, item recommendations or information, media, interactions, communications, warnings, etc., and may include one or more of text, audio, video, images, interactive user interface elements, operation of a device or machine, etc.

As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, terms such as “context” or the like generally encompass a circumstance, purpose, imminent or predicted condition, perceived or detected emotion, etc., as well as a task, need, desire, risk, or condition associated therewith, or combinations thereof. In other words, a context may include a semantic meaning that is not, or not only, physically descriptive of a surrounding environment, but also that includes an understanding of how a person may respond to such environment, or vice versa, or how such circumstance or the like may be desirably changed.

As used herein, a “machine-learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. By virtue of such training, a machine-learning model is converted from an un-trained and un-specific model to a model that is unique to and specifically configured for the particular purpose for which it is trained. In an example, training of a machine-learning model is analogous to a method of production in which the article produced is the trained model having unique characteristics by virtue of its particular training. Moreover, the result of training a machine-learning model using particular training data and for a particular purpose results in a technical solution to an inherently technical problem.

The execution of the machine-learning model, as well as various other tasks, may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In various operations, information may be “embedded” into a form adapted for processing by machine-learning technique. As used herein, an “embedding” generally encompasses a representation of information in a form that is machine-readable while preserving context. For example, an embedding is a numerical representation of an item of data (for example a word or sentence) that captures characteristics of the data so that items of data that are similar are close to each other in a space defined by the encoding. In various examples, information may be, for example, “vectorized,” “tokenized,” or the like in order to convert the information into a mathematical or numerical representation. As would be understood by one of ordinary skill in the art, in some examples, machine-learning may be used to train or tune an embedding algorithm. For instance, a Natural Language Process (NLP) may be trained on a corpus of text so as to determine an embedding model for future text. In some examples, an embedding utilizes or is based on application of an algorithm, e.g., a predetermined procedure or set of rules, to the input information. In some examples, e.g., in examples where information is embedded into vectors, each value in a vector may correspond to a separate aspect of the information. In examples where information is embedded as one or more tokens, each token may correspond to a separate aspect of the information. Any suitable embedding process may be used, e.g., Principal Component Analysis, Singular Value Decomposition, a Bidirectional Encoder Representations from Transformers (BERT), or any other transformer model or Large Language Model (LLM) encoder, etc.

In some instances, information may be pre-processed prior to being embedded, such as to prune extraneous or duplicative information, remove outliers, reduce dimensionality, etc. In some instances, post-processing may be applied to embedding. For example, an embedding of vectors may be expressed as an array, and a dimension reduction may be applied to the array, e.g., in order to reduce a complexity of the embedded information.

Conventionally, the context-awareness of an electronic application is generally limited to the electronic application's visibility of the device on which it operates. For example, an electronic application for providing a relevant advertisement to a user may only be aware of information available within an operating session on the user's device, e.g., what is being displayed by a web browser, information about the user stored on the device, e.g., in the form of a cookie, or information retrieved from an online resource, e.g., from a profile of the user stored on a server. Thus, while an electronic application may have visibility to the user's online activity and online history, such an electronic application generally has limited or no visibility regarding the real-world environment of the user and thus little to no understanding of the real-world context of the user. For instance, a conventional electronic application may be able to view a user's activity or history searching for an umbrella, but would be unable to determine that the user is walking through the rain. Moreover, in situations where the user is unable or unlikely to be using their device, e.g., when trying to find shelter from the rain, there may be no or insufficient interactions visible to the electronic application to which it may respond, or no adequate way in which to communicate with the user. An improved understanding of the context of a user's environment enables electronic applications to not only be more responsive, but also predictive or preemptive.

In an exemplary use case, a user may be on their way home from work. A context analysis system may receive multi-modal input, e.g., past location data, past transactions for a purchase of a public transit ticket, current location data, etc., and may convert such multimodal input into a standardized form. In some instances, such standardization may include using one type or source of data to obtain or determine a second. For instance, the type of location data discussed above may be applied to a weather prediction application in order to determine a likely weather condition, e.g., for a portion of the user's trip when they are walking outside to or from public transit. The standardized input, e.g., the user's predicted path of travel, the likely weather occurring at that path during their predicted time of travel, etc., may be used to generate an embedding of uniform multimodal context data, e.g., a machine-readable representation of a context for the user based on the various modalities of received data. That embedding may be processed in order to determine or generate content relevant to that context.

In one example, the embedding may be compared, e.g., via one or more machine-learning techniques, to previously determined embeddings for various content entries. For instance, the user's context (e.g., walking outside during likely rain along 5^{th} street at 5:00 PM) might have an embedding that is matched to a previously determined embedding for a 10% discount offer from a convenience store on 5th street that is open at 5:00 PM and that provides umbrellas.

Thus, in one example, before the user steps outside, a context system implementing one or more techniques according to this disclosure may cause the user's device to output a message indicating that it is likely to rain on their way home, and that they can pick up an umbrella at this convenience store with a discount. In another example, e.g., in which the user is determined to be walking, and thus may be less likely to engage with their mobile phone, the context system may identify an available display screen on 5th street between the user and the convenience store, and may cause the display to output a message that one or more of identifies the user, indicates the imminent rain, identifies the convenience store, or indicates the availability of the discount or the umbrella.

In some instances, the message(s) output to a user may be based on or sourced from the content entry matched to the user's context. In some instances, the message(s) may be at least partially generated, e.g., via an LLM or the like, e.g., based on one or more of the embedding of the user's context and the embedding of the matched context entry.

In another exemplary use case, a user's device may detect nearby music, and a music processing application may identify the band playing it. The context system may generate an embedding that includes the identification of the band, historical information regarding the user's music interests, or other data, and may use that embedding to determine a content entry relevant to that context, e.g., a nearby venue where that band is scheduled to play, a soon-to-expire coupon to an online music store that carried music by that band, a bar or restaurant that features a similar style of music, etc.

In examples such as the foregoing, visibility of the user's context by the context system enables not only a more personalized provision of content, but also content that may be predictive, preemptive, useful in the moment, or pertinent to the user's immediate situation. User engagement in such scenarios, e.g., providing content in a circumstance where it is needed, relevant, or pertinent, is generally higher than in conventional solutions, e.g., algorithms or the like that rely on user history or activity but have no or little visibility on the user's context. In other words, conventional content providers, not having sufficient visibility on the context of users, are generally less able to serve content at a time, place, or manner that is desired, relevant, or pertinent to a user's context, let alone predictive or preemptive or useful in the moment. Thus, a greater visibility of context for content providers may be beneficial.

In a further exemplary use case, various contexts may be predetermined, e.g., hungry, needs new shoes, travelling soon, has a young child, has a sibling with a birthday soon, etc. Such contexts may, for example, be predetermined via an entity or person associated with the context system, by analyzing contexts determined for one or more users, based on submissions by users or content providers, etc. A content provider may submit a content entry along with an association with one or more of such contexts. For example, a content provider associated with a clothing manufacturer may provide a content entry regarding a ski jacket, and may associate the content entry with such contexts as likely cold weather soon, interest in skiing, a location associated with winter sports. While the content provider may have used similar terms as keywords when providing content to, for example, a search provider, the way in which a user might then encounter such content was limited to engagement with the search provider. By utilizing the context system, the content entry may be provided to users for which the content entry is relevant to their specific context.

In one example, the context system may be configured to receive a plurality of content entries for various contexts. Content providers may, for example, submit content entries for specific contexts, e.g., alongside competing proposals for remuneration. In another example, the context system may determine the context(s) to associate with a content entry, e.g., via generating an embedding of the content entry. In a further example, context(s) determined via the context system may be weighted or ranked differently than contexts submitted by a content provider.

In a further exemplary use case, a user may be listening to music while relaxing at the beach during hot weather. The user may audibly mention that they haven't eaten in a while. A context system, using the aforementioned variety of information, may determine that an advertisement for a cold drink or ice cream would be a better match to serve to the user than an advertisement for clothing, or a warm meal. In an example, the context system may leverage factors such as the local weather, GPS location, visual camera (to identify the type of surrounding), or microphone (speech or sentiment) as inputs to an embedding system such as Sentence BERT or an LLM.

While several of the examples above involve providing content that includes offers, incentives, recommendations, or the like, it should be understood that techniques according to this disclosure may be adapted to any suitable type of content, such as audio, images, video, interactive content, etc. Moreover, it should also be understood that the examples above are illustrative only. The techniques and technologies of this disclosure may be adapted to any suitable activity. In an example, multimodal information from a computer environment, e.g., a video game, such as player-character information, environment information, user interaction history, etc., may be used to generate an embedding that may be used to select or generate content to serve to the user in the video game. In another example, multimodal information such as news reports, stock market data, scientific literature, etc., may be used to generate an embedding usable to select or generate a purchase recommendation, a current events summary, etc. In a further example, multimodal information such as medical imaging, text, environmental data, etc., may be used to generate an embedding usable to identify a medical prediction, or the like.

Presented below are various aspects of machine learning techniques that may be adapted to semantically understanding real-world context using multimodal input. As will be discussed in more detail below, machine learning techniques adapted to identifying content that is semantically relevant to a particular context may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., or other aspects that may be apparent to one of ordinary skill in the art based on this disclosure.

As illustrated in the examples above and elsewhere in this disclosure, the techniques disclosed herein provide various technical advantages that were not practical or practicable with conventional solutions. Conventional content selection may have little or no visibility on real-world context, and thus may be limited to input sourced from the session in which it is operating. By leveraging multimodal input, a context system such as disclosure herein may gain visibility not available via conventional solutions. Moreover, by standardizing such multimodal input, the disclosed context system may enable interoperability between various data types, sensor inputs, etc. Further, using embeddings of such data may enable efficient analysis or comparison of what would otherwise be complex and interrelated data and may, for example, result in a reduction in computing resources for processing data, storing data, or the like. Further, the disclosed machine-learning techniques provide for a representation of the complex concept of human or environmental context in a machine-readable form. These, and other advantages are discussed in further detail below with regard to the drawings.

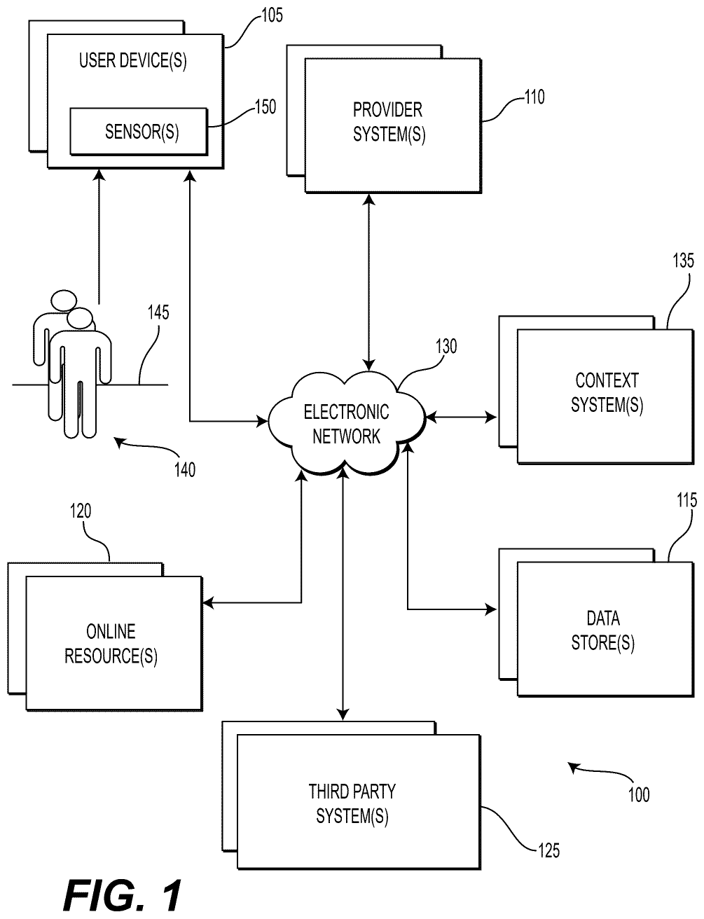

FIG. 1 depicts an exemplary infrastructure 100 that may be utilized with the techniques presented herein. One or more user device(s) 105, one or more provider system(s) 110, one or more data store(s) 115, one or more online resource(s) 120, and one or more third party system(s) 125 may communicate across an electronic network 130. As will be discussed in further detail below, one or more context system(s) 135 may communicate with one or more of the other components of the infrastructure 100 across electronic network 130. The one or more user device(s) 105 may be associated with one or more user(s) 140. The user 140 may be associated with an environment 145. For instance, the user may be located in or near the environment, may be travelling to or from the environment 145, may have a history of interactions associated with the environment 145, may be associated with a predicted action that corresponds to the environment 145, etc.

An environment 145, as used herein, generally encompasses one or more of a geographical location as well as one or more aspects or activities occurring at or near that geographical location. For example, an environment may include a user's location, the current weather, a conversation occurring nearby the user, traffic conditions, the presence of a restaurant nearby, etc. An environment may also include content being output by one or more computing device, e.g., the user device 105 or a third party system 125 such as, for example, nearby music, a billboard ad, a train schedule, a traffic light, media playing on a television, content displayed on a website page, etc.

In some embodiments, the components of the infrastructure 100 are associated with a common entity, e.g., a content provider or service, a financial institution, a transaction processor, or the like. In some embodiments, one or more of the components of the infrastructure 100 are associated with a different entity than another. The systems and devices of the infrastructure 100 may communicate in any arrangement. As will be discussed herein, systems or devices of the infrastructure 100 may communicate in order to one or more of generate, train, or use machine-learning techniques to semantically understand the environment 145 and serve semantically relevant content to the user 140, among other activities.

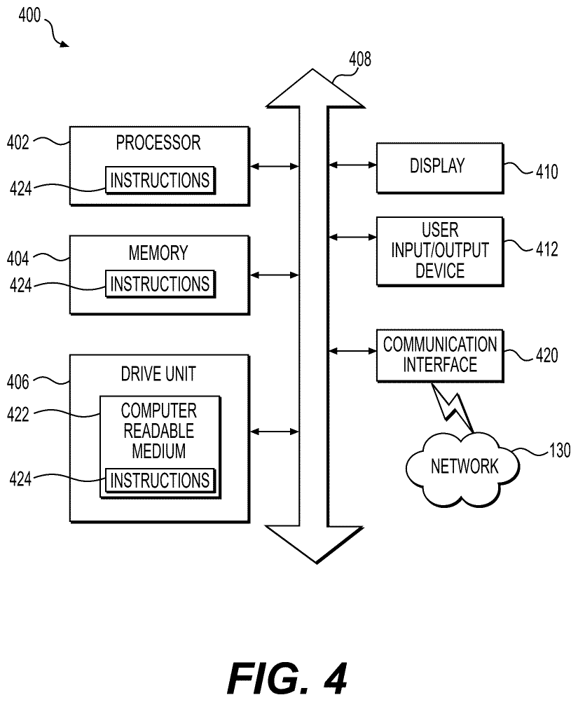

The user device 105 may be configured to enable the user 140 to access or interact with other systems in the infrastructure 100. For example, the user device 105 may be a computer system such as, for example, a desktop computer, a mobile device, a tablet, etc., as detailed with respect to FIG. 4. The user device 105 may be configured to obtain, receive, or store multiple modalities of information. As illustrated in FIG. 1, the user device 105 may include one or more sensors 150 configured to capture different modalities of data such as, for example, an audio sensor for capturing sounds such as speech, ambient noise, music, or other audio data, an imaging sensor for capturing images or video, a depth sensor such as an infrared sensor for capturing depth data, an accelerometer, a compass, a positioning device, a wireless antenna, a user interface, etc. In some instances, the user device 105 may obtain information captured by a sensor. In some instances, the user device 105 may obtain information indirectly via a sensor. For example, the wireless antenna may be used to obtain information from other sources.

In some embodiments, the user device 105 may include one or more electronic application(s), e.g., a program, plugin, browser extension, etc., installed on a memory of the user device 105. In some embodiments, the electronic application(s) may be associated with one or more of the other components in the infrastructure 100. For example, the electronic application(s) may include one or more of system control software, system monitoring software, software development tools, etc. In various embodiments, historical information for one or more modalities may be stored on one or more of the memory of the user device 105, on a memory of a device in communication with the user device 105, e.g., the data store 115, or the like.

The provider system 110 may include a server system, an electronic data system, or computer-readable memory such as a hard drive, flash drive, disk, etc. In some embodiments, the provider system 110 includes or interacts with an application programming interface for exchanging data to other systems, e.g., one or more of the other components of the infrastructure 100. In an example, the provider system 110 may include or be associated with an e-commerce application. In some embodiments, the provider system 110 may store, provide, or generate one or more content entries. In various embodiments, a content entry may include, for example, information regarding an item, an offer for an item, a discount or incentive for an item, or the like. In some embodiments, the content entry may include or be associated with one or more predetermined contexts or one or more offers for remuneration. In some embodiments, the provider system 110 may be configured to communicate with other systems or devices in the infrastructure 100, as discussed in further detail below.

The data store 115 may include a server system, an electronic data system, computer-readable memory such as a hard drive, flash drive, disk, etc. In some embodiments, the data store 115 includes or interacts with an application programming interface for exchanging data to other systems, e.g., one or more of the other components of the infrastructure 100. The data store 115 may include or act as a repository or source contexts, embeddings, content entries, provider information, user information, machine-learning models or algorithms, training data, data processing algorithms such as Natural Language Processing algorithms, image-processing algorithms, audio-processing algorithms, or any other suitable algorithm, model, or the like for processing any suitable modality of data.

The online resource 120 may include a server system, an electronic data system, computer-readable memory such as a hard drive, flash drive, disk, etc. In some embodiments, the online resource 120 includes or interacts with an application programming interface for exchanging data to other systems, e.g., one or more of the other components of the infrastructure 100. The online resource 120 may be configured to receive first data, e.g., a first modality of data related to the environment 145, and to generate or obtain second data also related to the environment 145. The second data may be in the same or a different modality as the first data. In an example, a weather algorithm may be configured to receive location or time information, e.g., current information from the user device 105 or predicted information from the context system 135, and determine a corresponding weather prediction. In another example, an event algorithm may receive first information such as a band name, style of music, venue, or the like, and determine an upcoming show time or related information. In other words, an online resource 120 may be usable to leverage one or more modalities of information related to the environment 145 in order to obtain further information related to the environment 145.

Moreover, it should be understood that, in some embodiments, the functionality discussed above performed by an online resource 120 may be at least partially performed onboard the user device 105, e.g., based on stored or predicted information. For example, the user device 105 may have stored information, e.g., stored in a memory of user device 105, about upcoming weather predictions. Rather than communicating with an external device, the user device 105 may accessed the stored information in the memory.

The third party system 125 may include an output device such as a display, speaker, or the like, and may be configured to receive instructions or information from the context system 135, e.g., via the electronic network 130. In an example, the third party system 125 may include a display screen in a storefront window that is accessible by the context system 135 to output information to the user 140 in the environment 145.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like.

The context system 135 may include a server system, an electronic data system, computer-readable memory such as a hard drive, flash drive, disk, etc. In some embodiments, the context system 135 includes or interacts with an application programming interface for exchanging data to other systems, e.g., one or more of the other components of the infrastructure 100. The context system 135 may include or access, for example, one or more pre-processing algorithms or models, one or more context models or algorithms, or one or more post-processing algorithms, any or all of which may include one or more machine-learning models or algorithms.

As discussed in further detail below, the context system 135 may one or more of generate, store, train, or use a machine-learning technique such as a model or algorithm configured to preprocess one or more modalities of data, generate an embedding based on multiple modalities of data, match an embedding for an environment 145 with an embedding for a content entry, generate a content entry based on an embedding for an environment 145, as well as other tasks. The context system 135 may include a machine-learning model or instructions associated with the machine-learning model, e.g., instructions for generating a machine-learning model, training the machine-learning model, using the machine-learning model etc. The context system 135 may include instructions for retrieving context data or content data, adjusting context data or content data, e.g., based on the output of the machine-learning model, or instructing the user device 105 to output context data or content data, e.g., as adjusted based on the machine-learning model. The context system 135 may include training data, e.g., one or more modalities of data, one or more embeddings of such data, or the like, and may include ground truth, e.g., content semantically relevant to such data, embeddings based on such content, or the like.

In some embodiments, a system or device other than the context system 135 is used to generate or train the machine-learning model or algorithm. For example, such a system may include instructions for generating the machine-learning model, the training data and ground truth, or instructions for training the machine-learning model. A resulting trained-machine-learning model may then be provided to the context system 135.

Generally, a machine-learning model or algorithm includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. In unsupervised learning, patterns, correlations, or clusters of input samples may be used to determine one or more metrics or features of the samples usable to differentiate between related subsets of the samples. In semi-supervised learning, unsupervised and supervised approaches may be combined.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine-learning model, e.g., compare the output of the trained model with the ground truth for that portion of the training data to evaluate an accuracy of the trained model. The training of the machine-learning model may be configured to cause the machine-learning model to learn associations between information such as multimodal data, context data, content data, or the like such that the trained machine-learning model is configured to determine an output in response to input data based on the learned associations. Particular selection or application of training data, such as discussed in various embodiments of this disclosure, may inhibit or reduce impact of concerns such as biasing (e.g., via selection, truncation, or the like), overfitting, under-fitting, etc.

In some instances, a machine-learning model or the like includes an encoder layer, an embedding layer, or the like. In some embodiments, the encoding layer or the like of a trained model may be extracted to form an embedding algorithm. Similarly, a decoder portion or the like of a trained model or algorithm may be used to at least partially create generative content based on an input embedding.

In some instances, training using one set or type of data may be used or adapted to another set of data. For example, a model initially trained on one data set may require less samples or time to train on a second data set. In another example, initial training may result in a base model that may be tuned with an additional data set so as to form a particularized model specific to circumstances of the additional data set. In an example, a model may be trained to learn associations between content entries and contexts, and then adapted to apply to associations between the contexts and multimodal data, or vice versa.

In various embodiments, the variables of a machine-learning model may be interrelated in any suitable arrangement. For example, in some embodiments, the machine-learning model may include image-processing architecture that is configured to identify, isolate, or extract features, geometry, or structure in one or more modality of the multimodal input. For instance, the machine-learning model may include one or more convolutional neural networks (“CNN”) configured to identify features in any modality of data that may be expressed in an array, and may include further architecture, e.g., a connected layer, neural network, etc., configured to determine a relationship between the identified features in order to determine more complex features in the input data.

In some instances, different samples of training data or input data may not be independent. For example, some types of multimodal data may include samples that are associated, e.g., audio or video data captured over time or streamed, weather data for different time periods or for different locations, price data for similar items, musical artists with similar styles, etc. Thus, in some embodiments, the machine-learning model may be configured to account for or determine relationships between multiple samples.

For example, in some embodiments, one or more machine-learning models of the context system 135 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of images as input, and generate a sequence of locations, e.g., a travel path, as output.

Various features may be included or used with any suitable machine learning model. For instance, a model may be configured to receive or determine a relative positioning of data or portions of data in samples (e.g., position of words in a sentence, location of pixels in an image, etc.), and use such positions as a portion of the input to the model. In another instance, a model configured to utilize attention may be configured to weigh, determine, or the like how different samples or portions of samples impact the output of the model, and may incorporate such data into the training process. An example of a model that utilizes information on relative positioning and attention is a transformer model. One implementation incorporating a transformer is LLM.

Any suitable type of machine learning model or combination of machine learning models may be used. Operations conducted by one model in some embodiments may be distributed amongst a plurality of models in other embodiments, or vice versa.

Examples of preprocessing algorithms or models that may be included in the context system 135 include an NLP process, an image analysis process, an audio analysis process, or any other suitable process. An NLP process may be used, for example, to parse textual data, e.g., browse history, user information, device information, log files, or text included in or associated with any other information for a variety of tasks such as, for example, summarization, determining sentiment, determining emotion, determining attention (e.g., a relation or context between text terms, a domain-specific meaning, etc.), determining a category or categorization of input text, etc. As will be discussed in further detail below, an NLP process may also be used to generate an embedding of text data. An NLP process may apply mathematical algorithms (e.g., reverse or inverse frequency), may apply domain-specific knowledge (e.g., by applying domain-specific rules or by using a domain-specific lexicon), or may apply one or more machine-learning techniques, e.g., to learn associations between different terms or to learn an embedding scheme for input text. An NLP process may also be used to reduce complexity of input text data, e.g., by removing nonce or stop words, identify a speaker, etc.

An image analysis process may be configured to identify features in an input image. However, as noted above, an image analysis algorithm may also be adapted to various other types of data that may be represented as an array. Features that may be identified via such an algorithm may that include visual features of an object captured in an image, but may also include patterns or trends present in the array data.

An audio analysis process may be configured to one or more of identify one or more speakers in captured audio data, convert spoken language to text, identify one or more sources of captured noise, identify a song or an artist associated with such a song, etc.

As noted above, an online resource 120 or other pre-processing process may be usable to leverage first data associated with the environment 145 to obtain second data also associated with the environment 145. In some embodiments, the context system 135 may include an API configured to interact with one or more online resources 120. For instance, an API may transmit location data from the user device 105 along with a request for weather data to an online resource 120. In another example, an API may transmit an image, an audio sample, or the like to an LLM to obtain a text description to such submission. In a further example, location data such as geographical coordinates may be used via an API to obtain a general location, such as a city, an address, a neighborhood, or the like.

Further, such leveraging of data to obtain other data may be repeated, or may be recursive. For instance, a neighborhood obtained from geographical coordinates may be used to obtain an image of that neighborhood, which may itself be used to obtain a text description of that image.

In some embodiments, the context system 135 may include a database or listing of identified third party systems 125. Such third party systems 125 may be categorized by one or more of location, type, available interactions, cost, availability, etc. The context system 135 may include an API or the like for interacting with, instructing, or transmitting information to one or more third party systems 125.

In various embodiments, the context system 135 may include one or more standardization processes. In an example, any modalities of data that are not text-based may be converted into text. For instance, an image may be converted into a textual description of the image, e.g., via one or more of the processes discussed above. In one example, each modality may be converted to a delimited portion of text, e.g., a separate sentence, a separate paragraph, etc. In another example, each modality of data may be converted into one or more tokens, e.g., machine-readable units. In some embodiments, the output of such standardization is an embedding. In some embodiments, the output is usable to generate an embedding. For example, a set of sentences, each sentence including text descriptive of data from a different modality, may be applied to an encoder to generate an embedding. In another example, respective tokens for each modality may be fed into an encoder to generate an embedding, e.g., that interrelates the different tokens. In a further example, the standardized data may be used to generate an output vector in a latent space. Any suitable standardization process may be used.

As noted in one or more of the examples above, the context system 135 may be configured to match an embedding of context data from an environment 145 to an embedding of a content entry. In various embodiments, any suitable matching process may be used. In an example, the context system 135 may include a cosine similarity engine, a k-nearest neighbor engine, or the like.

In another example, an embedding from the environment 145 may be matched with an embedding generated from a description of a predetermined context, e.g., to match the context of the environment 145 with one of the predetermined contexts. The identification of the predetermined context may be usable to identify a subset of associated content entries and their embeddings for comparison with the embedding from the environment 145. In other words, in some embodiments, rather than comparing the context of the environment 145 with each available content entry's embedding, the context of the environment 145 may only be compared with the embeddings of content entries associated with one or more predetermined context determined to relate to the context of the environment 145. This subdivision may increase the efficiency of the matching, or decrease the amount of data needing to be compared or analyzed. In some embodiments, different matching processes may be applied for different contexts, different modalities of data, etc.

In some embodiments, a content entry may be selected based on a matching score or the like between its embedding and the embedding in the environment 145. In some embodiments, a threshold matching score may be needed to obtain a match. A lack of a content entry with a sufficient matching score may, in various embodiments, result in no content entry being selected, additional data being captured from the environment 145, or modification or generation of a content entry.

In some embodiments, the context system 135 may be configured to generate a content entry based on the embedding of the environment 145. For instance, an LLM may be configured to generate a content entry based on the embedding. In some embodiments, the context system 135 may include one or more templates, criteria, boundaries or ranges, or the like for generating or modifying content entries. For example, the context system 135 may store data received from one or more providers indicating that they are available for generative content. Such data may also include, for example, limitations for such generation such as particular contexts, limitations on available actions or interactions, limitations on geographical area of applicability, quantity, timing, etc.

In an illustrative example, the context system 135 may include data that a provider is available for a generative discount pertaining to outerwear or extreme weather gear. The provider may have specified a maximum percentage discount or maximum discount value or the like. The environment 145 of a user 140, for the purpose of illustration, may be a cold-weather environment in which the user 140 is likely to partake in outdoor winter activities. The context of the environment 145 may be used by the context system 135 to generate a content entry that includes a discount offer at a local clothes vendor for a winter jacket. The vendor may have been selected based on a preexisting association with the provider or the context system 135, and the amount for the discount may be based on the criteria submitted by the provider. In this manner, content entries may not be limited to predetermined submissions.

In some embodiments, the context system 135 includes one or more processes for monitoring user engagement with content entries. For instance, in some embodiments, the context system 135 is configured to obtain data such as, for example, transaction data, interactions with the user device 105, location data from the user device 105, or the like to determine information regarding interactions between the user 140 and a content entry. For example, transaction data may be parsed, e.g., via an NLP process, to determine whether an item pertaining to a discount in a content entry was obtained by the user 140. In another example, location data may be analyzed to determine whether the user 140 viewed a notification on a third party system 125, whether the user 140 changed their navigation resulting from such a notification, or whether the user 140 went to a location associated with the content entry.

In some embodiments, the context system 135 may include one or more flag processes configured to generate one or more monitoring flags based on a content entry matched to an environment 145. In some embodiments, monitoring flags for a content entry may be predetermined. In some embodiments, monitoring flags may be generated. For instance, a content entry matched to a context for an environment 145 may be displayed by a third party system 125, and may be associated with a provider. The context system 135 may, for example, apply an LLM, an NLP process, or the like to the content entry to identify one or more activities of the user 140 that may be associated with the content entry and that may be monitored by one or more systems associated with or accessible via the context system 135. The context system 135 may access or generate API interactions with such systems in order to enable such monitoring. The results of such monitoring, e.g., engagement data or the like, as well as analysis thereof may be stored by the context system 135 or made available to the provider. Thus, a provider may be able to determine, e.g., in real or near real time, an engagement rate of users with a content entry, e.g., for a particular context. Moreover, in some embodiments, the context system 135 may be configured to apply such information, e.g., engagement rate, to remuneration rates for content entries submitted from providers.

Although depicted as separate components in FIG. 1, it should be understood that a component or portion of a component in the infrastructure 100 may, in some embodiments, be integrated with or incorporated into one or more other components. For example, a portion of the provider system 110 may be integrated into a third party system 125 or the like. In another example, the context system 135 may be integrated the data store 115, or vice versa.

In another example, at least a portion of the context system 135 may be integrated into the user device 105, e.g., as an onboard application, extension, instance, or the like. For example, it may be beneficial for information regarding the environment 145 to remain local to the user device 105. In an example, processes for pre-processing, standardization, embedding, or post-processing may be included on the user device 105, with the output thereof transmitted to the context system 135, e.g., for matching with semantically related content entries. Standardized or embedded data may be less identifiable with the user 140, and thus sequestering more identifiable data on the user device 105 may improve a privacy and security of information pertaining to the user 140. In another example, information may be anonymized at one or more stages, e.g., before being conveyed to the context system 135.

In some embodiments, operations or aspects of one or more of the components discussed above may be distributed amongst one or more other components. Any suitable arrangement or integration of the various systems and devices of the infrastructure 100 may be used.

In the following methods, various acts may be described as performed or executed by a component from FIG. 1, such as the context system 135, the user device 105, a third party system 125, or components thereof. However, it should be understood that in various embodiments, various components of the infrastructure 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

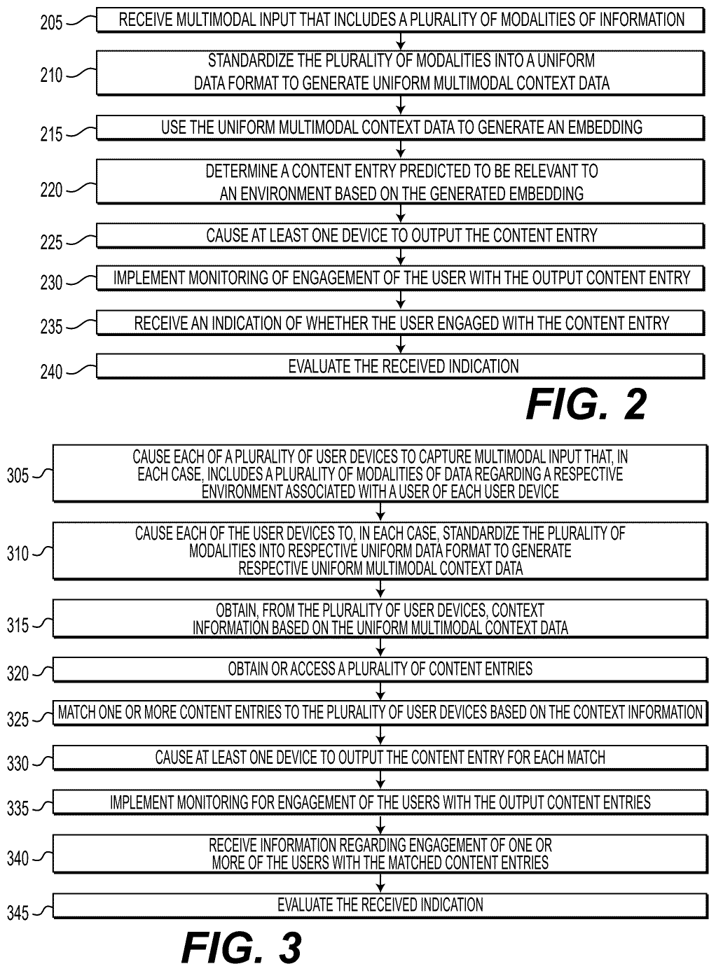

FIG. 2 illustrates an exemplary process for semantically interpreting an environment 145 for a user 140 using multimodal data, such as in one or more of the examples discussed above. Moreover, in the following method, the user device 105 and the context system 135 are discussed as separate entities. However, it should be understood that in various embodiments, functionality or aspects of one may be integrated into or distributed across the other or any other suitable systems or devices, e.g., for privacy, computing efficiency, or any other suitable reason.

In some embodiments, the user 140 may register for an electronic application or service associated with the context system 135. In some embodiments, the user 140 may, e.g., via the user device 105, opt in to one or more modalities of monitoring. For example, the user 140 may select which information about the user 140 (e.g., on the data store 115), which sensor(s) 150, or which other systems or services are accessible for monitoring one or more aspects of the environment 145.

In an exemplary embodiment, the context system 135 may setup, schedule, or initiate monitoring of the environment 145, e.g., using the one or more modalities opted in via the user 140. Such monitoring may, in various embodiments, be in real or near real time, continuous, periodic, or may occur in response to a stimulus such as the user initiating the electronic application, initiating an instruction, etc. In some embodiments, one modality may be monitored continuously or periodically, and may act as a trigger for monitoring another modality.

At step 205, the context system 135 may receive, e.g., via the user device 105, multimodal input. As noted above, the multimodal input includes a plurality of modalities of data regarding the environment 145 that is associated with the user 140 of the user device 105. As noted above, such multimodal input may include, for example, information captured by one or more sensors 150, information indicative of one or more aspects of the environment 145 that is stored on the user device 105 or any other devices such as the data store 115. The plurality of modalities included in the multimodal input may include, for example, one or more of an image modality, an audio modality, location information, information about the location (description, contents, travel information, etc.), browse history, interaction history of the user device 105, device information of the user device 105, information regarding third party systems 125, etc.

At step 210, the context system 135 may standardize the plurality of modalities into a uniform data format to generate uniform multimodal context data. In an example, one or more pre-processing processes may be used to generate a text description of a non-textual modality of data, such that all of the modalities may be represented textually. In another example, each modality of data may be tokenized, vectorized, or the like, or otherwise represented in a uniform, machine-readable form. Any suitable process or algorithm may be used, e.g., an encoder from a trained machine-learning model such as a BERT, one or more encoder heads of an LLM, or the like. In some embodiments, each modality is represented as a separate, delimited, entry, e.g., as a separate word, separate sentence, separate token, separate set of tokens, separate vector, separate array, etc. Multimodal data that has been standardized such as in the foregoing examples is referred to herein as uniform multimodal context data.

In some embodiments, the standardization process includes converting a modality of data into a different modality, or using one modality of data to obtain or modify another. In an example, the context system 135 may provide data associated with one or more modalities to an electronic application, e.g., an online resource 120, configured to obtain further data based on the provided data. The context system 135 may then receive the further data and represent the further data in the uniform multimodal context data.

At step 215, the context system 135 may use the uniform multimodal context data to generate an embedding. In some embodiments, such as where an encoder was used to standardize the multimodal data, the uniform multimodal context data may also be or include the embedding. In some embodiments, such as where each modality is represented as text, a separate embedding or encoding process may be applied to the uniform multimodal context data. In some embodiments, e.g., where each modality is represented as a separate, delimited entry, the embedding process may include applying an encoder with attention to the uniform multimodal context data. As would be understood by one of ordinary skill in the art, attention is a process, commonly associated with LLMs, by which portions of input data are interpreted under the lens of and modified by their relationship to other portions of the input data. In an illustrative example, multimodal input may include first data representative of audio data with spoken language and second data representative of a location. An attention process may determine, based on associations learned via training, likely associations of the first data with the second data, and vice versa. The associations may be used to modify the first or second data such that the “attention” paid to the other data is incorporated.

At step 220, the context system 135 may determine a content entry predicted to be relevant to the environment 145 based on the generated embedding. In some embodiments, the content entry predicted to be relevant is selected from amongst a plurality of predetermined content entries.

In an example, the context system 135 may obtain or access embeddings for a plurality of content entries. For instance, content entries may be submitted by providers, generated (e.g., via an LLM or the like) and stored via the context system 135, the data store 115, or the like. Embeddings for such content entries may be generated. In some embodiments, a same or similar process is used to generate the embeddings of the content entries as is used to generate the embedding of the multimodal input. In some embodiments, further information regarding the context of the environment is incorporated into the embedding process for the content entries. For instance, an embedding of a content entry may be at least partially based on one or more parameters such as whether the content entry is associated with an online interaction, whether the content entry is associated with an in-person interaction, whether an interaction target of the content entry has a preexisting association with the user or with a content entity, or whether an interaction associated with the content entry can be accessed or completed within a threshold period of time. Any other suitable parameters may be used. In an example, a parameter to be embedded with the content entry may include any aspect that may impact a semantic relevance of the content entry to the environment 145 of the user.

The context system 135 may compare the embedding of the uniform multimodal context data with the embeddings of the plurality of content entries. Any suitable comparison process may be used such as, for example, cosine similarity, k-nearest neighbor analysis, or the like. The context system 135 may select the content entry from the plurality of entries having an embedding with a highest similarity to the embedding of the uniform multimodal context data.

In another example, determining the content entry predicted to be relevant to the environment 145 includes applying a generative model to the embedding of the uniform multimodal context data to generate the content entry. As would be understood by one of ordinary skill in the art, generative models may include a combination of encoder and decoder layers. A decoder layer of a trained model, e.g., the model trained to generate the embedding, may be applied to the embedding in order to generate a content entry based on the multimodal input. In some embodiments, the context system 135 may apply one or more additional parameters or criteria to the generative model such as, for example, boundaries or criteria for the content entry, or the like. In some embodiments, the context system 135 may transmit information regarding a generated content entry to an associated provider. For instance, in a circumstance where the context system 135 generates a recommendation or incentive for an item offered by a provider, the context system 135 may notify the provider, or may setup, schedule, or initialize monitoring configured to detect engagement of the user 140 with the generated content entry, such as monitoring of transaction data, inventory data, location data, or the like.

In a further example, determining the content entry predicted to be relevant to the environment 145 may include soliciting content entries based on the particular context of the environment 145. For instance, the context system 135 may generate a context description for the environment 145 based on the embedding. In an example, the context description may convey a need, desire, benefit, risk, or the like that may be serviced or satisfied via interaction with a provider. In an illustrative example, location data of a user 140 along with weather data, travel data, etc., may result in an embedding that the context system 135 may use to generate a description indicative that the user 140 is about to be walking in the rain and needs protection from the elements. The context system 135 may provide the context description to one or more content entities, e.g., providers, which may submit content entry proposals in response. For example, a provider with a venue nearby the user may submit an incentive for an offer of an umbrella. The context system 135 may receive such proposals, and select at least one such proposal as the content entry, e.g., based on a matching between the embedding and embeddings of the proposals, based on remuneration values associated with the proposals, or the like.

At step 225, the context system 135 may cause at least one device to output the content entry. In one example, the content system 135 may cause the user device 105 to output the content entry. In another example, the context system 135, instead of or in addition to the user device 105, may cause one or more third party systems 125 to output the content entry. In some instances, the device used to output the content entry may be determined based on the embedding, based on the content entry, based on an opt in setting by the user 140, etc. For example, the context of the environment 145 may indicate whether a user 140 is more likely to be using the user device 105 or have visibility or access to a third party system 125. In some embodiments, the context system 135 may identify one or more third party systems 125 in operational proximity to the user device 105. In other words, the context system 135 may identify third party systems 125 situated such that their output is likely to reach the user 140. The context system may cause one or more identified third party systems 125 to output the content entry.

At step 230, the context system 135 may implement monitoring of engagement of the user 140 with the output content entry. For example, the context system 135 may set up, initialize, or enable monitoring of one or more devices or modalities for information indicative of engagement of the user 140 with the content entry.

In one example, the monitoring may include obtaining or accessing transaction information and determining, based on such information, whether the user 140 completed a transaction associated with the content entry. In some instances, the content entry may include information indicative of an associated transaction to monitor for. In some instances, such transaction information may be provided by the provider or another entity. In some instances, the context system 135 may generate such information, e.g., by applying a predictive model to the content entry, e.g., an LLM or the like. In another example, the monitoring may include determining whether location information of the user device 105 indicates that the user 140 traveled to a location associated with the content entry, or was at such a location at an associated time or for an associated period of time. Information from any modality or any combination of modalities, as well as information from the user device 105, a third party system 125, or any other suitable device may be used for such monitoring. In some instances, a monitoring model may be trained on user interactions over time in order to learn associations between various modalities of information, user actions or interactions, and whether users have engaged with different content entries. In some instances, the monitoring may include receiving direct user feedback, e.g., an indication from the user 140, e.g., via the user device 105, such as an indication that the content entry was relevant or not, was wanted or not, was timely or not, etc.

At step 235, the context system 135 may receive, e.g., via the monitoring, an indication of whether the user 140 engaged with the content entry. At step 240, the context system 135 may evaluate the received indication. In one example, the indication may be used to refine, retrain, or tune the embedding process, matching process, or the like, e.g., to more accurately reflect how the user 140 interacts with and responds to the environment 145. In another example, the context system 135 may determine one or more metrics descriptive of the user response to the content entry. For instance, the context system 135 may determine engagement rates for a content entry, for a particular context, for a particular user, or combinations thereof. Such metrics may be provided to a provider, used to adjust a remuneration rate for a content entry, used to adjust the embedding or matching process or the like, or any other suitable purpose.

FIG. 3 illustrates an exemplary process for semantically linking content to a real-world environment. An electronic application, service, or the like may be supplied to user devices 105 of a plurality of users 140. In an example, an electronic applicant may be provided that is configured to operate in a background context, e.g., in a manner that is generally opaque to the user. The electronic application may have access to one or more sensors of a corresponding user device 105 and/or data stored on the user device 105. In an example, a user may opt in to access for each such sensor or location on the memory of the user device that is accessible to the electronic application.

At step 305, the context system 135, e.g., via the supplied electronic applications, may cause each of the user devices 105 to capture multimodal input that, in each case, includes a plurality of modalities of data regarding a respective environment associated with a user 140 of each user device 105. In an example, the electronic application of a user device 105 may be caused to capture one or more of location data, accelerometer data, audio data, video data, network connection or activity data, device information, user data, or the like. For instance, the user device 105 may be caused to capture multimodal input using the sensors or data opted in for access by the user.

At step 310, the context system 135, e.g., via the supplied electronic applications, may cause each of the user devices 105 to, in each case, standardize the plurality of modalities into respective uniform data format to generate respective uniform multimodal context data. In an example, each modality of data captured by a user device 105 may be used to generate a respective sentence of text, token, or the like that together with the other respective sentences, tokens, etc. form the respective uniform multimodal context data for the user device 105.

At step 315, the context system 135 may obtain, from the plurality of user devices 105, context information based on the uniform multimodal context data. In some embodiments, the context information includes or is based on an embedding of the multimodal data. In some embodiments, the context information is generated by applying a model, such as an LLM, or a decoder thereof, to an embedding. In some embodiments, the context information includes an identification of a context from a predetermined list of contexts. For instance, the respective uniform multimodal context data for a user device 105 or an embedding thereof may be evaluated to identify a closest match in the predetermined list of contexts. Any suitable comparison technique may be used.

At step 320, the context system 135 may obtain or access a plurality of content entries. In some embodiments, the content entries have been submitted by one or more providers. In some embodiments, the content entries have been generated based on the context information. In one embodiment, the context system 135 may determine a set of contexts based on the context information received from the user device 105, and may provide the set of contexts to one or more entities, e.g., one or more providers. The context system 135 may then receive at least one content entry proposal from the one or more content entities. In an example, each content entry may have a predetermined association with one or more context in the set of contents. For instance, a food services provider may submit a content entry, and flag the content entry as one or more of restaurant-related, food related, related to a particular food style, related to a particular geographical location, etc. In some embodiments, the content entries have predetermined associations with one or more predetermined contexts. In some embodiments, one or more contexts are determined for the content entries.

At step 325, the context system 135 may match one or more content entries to the plurality of user devices 105 based on the context information. Any suitable matching process may be used. At step 330, the context system 135 may cause at least one device to output the content entry for each match. In an example, in some instances, the context system 135 may cause a user device 105 to output the matched content entry. In some instances, the context system 135 may cause a third party system 125 to output the matched content entry.

In an illustrative use-case example, when submitting a content entry, e.g., an offer for a discount on winter weather-ware, a content provider may be able to select a particular context, e.g., users likely to be travelling to a region with cold weather. The context system 135 may match the provided content entry to the user device 105 of any user that, based on a respective context of that user, is likely to be travelling to a cold-weather region.

At step 335, the context system 135 may implement monitoring for engagement of the users 140 with the output content entries. At step 340, the context system 135 may receive information regarding engagement of one or more of the users 140 with the matched content entries. At step 345, the context system 135 may evaluate the received indications, e.g., in order to update a matching criteria of the one or more content entries based on the indication. For instance, engagement or lack thereof, as well as other types of user feedback, may be used to update, tune, or retrain the matching criteria.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 2 and 3, may be performed by one or more processors of a computer system, such any of the systems or devices in the infrastructure 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

FIG. 4 is a simplified functional block diagram of a computer 400 that may be configured as a device for executing the methods of FIGS. 2 and 3, according to exemplary embodiments of the present disclosure. For example, the computer 400 may be configured as the context system 135 or another system according to exemplary embodiments of this disclosure. In various embodiments, any of the systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for semantically interpreting a real-world environment, comprising:
receiving, via a user device, multimodal input that includes a plurality of modalities of data regarding an environment associated with a user of the user device, wherein:
each modality of data of the plurality of modalities of data includes a different data type in a different data format; and
the plurality of modalities includes two or more of an image modality for image data, an audio modality for audio data, a location modality for location data, a browsing modality for browse history data, a user interface modality for data describing an interaction history of the user device, or a hardware modality for data describing device information of the user device;
standardizing the plurality of modalities of data that is in the different data formats into a uniform data format to generate uniform multimodal context data;
generating an embedding of the uniform multimodal context data; and
determining a content entry predicted to be relevant to the environment associated with the user based on the generated embedding.

2. The computer-implemented method of claim 1, wherein determining the content entry predicted to be relevant to the environment includes:
obtaining embeddings for a plurality of content entries;
comparing the embedding of the uniform multimodal context data with the embeddings of the plurality of content entries; and
selecting the content entry from the plurality of entries having an embedding with a highest similarity to the embedding of the uniform multimodal context data.

3. The computer-implemented method of claim 2, wherein embeddings of the plurality of content entries are based on respective values for one or more parameters that include whether the content entry is associated with an online interaction, whether the content entry is associated with an in-person interaction, whether an interaction target of the content entry has a preexisting association with the user or with a content entity, or whether an interaction associated with the content entry can be accessed or completed within a threshold period of time.

4. The computer-implemented method of claim 1, wherein determining the content entry predicted to be relevant to the environment includes applying a generative model to the embedding to generate the content entry.

5. The computer-implemented method of claim 1, wherein determining the content entry predicted to be relevant to the environment includes:
generating, based on the embedding, a context description for the environment;
providing the context description to one or more content entities;
receiving at least one content entry proposal from the one or more content entities that are responsive to the context description; and
selecting one of the at least one content entry proposals as the content entry.

6. The computer-implemented method of claim 1, wherein the standardizing of the plurality of modalities of data into the uniform data format to generate the uniform multimodal context data includes one or more of:
converting any non-text modalities of data into text; or
converting each of the plurality of modalities into one or more tokens.

7. The computer-implemented method of claim 1, wherein the standardizing of the plurality of modalities of data into the uniform data format to generate the uniform multimodal context data includes:
providing data associated with one or more modality to an electronic application configured to obtain second data based on the provided data; and
receiving the second data and representing the second data in the uniform data format.

8. The computer-implemented method of claim 1, wherein each modality of data in the plurality of modalities is represented in the uniform multimodal context data as a separate delimited entry.

9. (canceled)

10. The computer-implemented method of claim 1, further comprising:
causing the user device to output the content entry.

11. The computer-implemented method of claim 1, further comprising:
identifying a further device in operational proximity to the user device; and
causing the further device to output the content entry.

12. A computer-implemented method of semantically linking content to a real-world environment, comprising:
causing each of a plurality of user devices to:
capture multimodal input that includes a plurality of modalities of data regarding a respective real-world environment associated with a user of each user device wherein each modality of data of the plurality of modalities of data includes a different data type in a different data format; and
standardize the plurality of modalities of data into a uniform data format to generate uniform multimodal context data;
obtaining, from the plurality of user devices, context information based on the uniform multimodal context data; and
matching one or more content entries to the plurality of user devices based on the context information.

13. The computer-implemented method of claim 12, further comprising:
causing the matching user devices to output a corresponding one of the one or more content entries.

14. The computer-implemented method of claim 12, further comprising:
determining a set of contexts based on the context information;
providing the set of contexts to one or more content entities; and
receiving, as the one or more content entries, at least one content entry proposal from the one or more content entities identifying one or more context in the set of contents.

15. The computer-implemented method of claim 12, wherein the one or more content entries have predetermined associations with one or more predetermined contexts.

16. The computer-implemented method of claim 12, wherein the context information includes an identification of a context from a predetermined list of contexts.

17. The computer-implemented method of claim 12, further comprising:
receiving an indication of engagement of one or more user with the one or more content entries; and
updating a matching criteria of the one or more content entries based on the indication.

18. The computer-implemented method of claim 17, further comprising:
repeating at least the matching using the updated matching criteria.

19. The computer-implemented method of claim 12, further comprising, for each of the matching user devices:
identifying a further device proximate to the matching user device; and
causing the further device to output a corresponding content entry.

20. A system for semantically interpreting a real-world environment, comprising:
at least one memory storing instructions;
a plurality of sensors, each sensor configured capture a different sensory input as a different modality of data having a different data format; and
at least one processor operationally connected to the at least one memory and the plurality of sensors, and configured to execute the instructions to perform operations, including:
capturing, via the plurality of sensors, multimodal input that includes a plurality of modalities of data regarding an environment associated with a user of the system;
standardizing the plurality of modalities of data into a uniform data format to generate uniform multimodal context data;
generating an embedding of the uniform multimodal context data; and
determining a content entry predicted to be relevant to the environment associated with the user based on the generated embedding.
